(19) United States
(12) Patent Application Publication
(10) Pub. No.: US 2020/0027046 A1
(43) Pub. Date: Jan. 23, 2020

(54) SMART MONITORING

(71) Applicant: International Business Machines Corporation, Armonk, NY (US)

(72) Inventors: Michael D. Woods, Palos Park, IL (US); Yea Jane Chu, Chicago, IL (US); Jing-Yun Shyr, Naperville, IL (US)

(21) Appl. No.: 16/037,613

(22) Filed: Jul. 17, 2018

(51) Int. Cl. G06Q 10/06; G06F 17/30

(52) U.S. Cl. CPC G06Q 10/06393; G06F 17/30536; G06F 17/30572

(57) ABSTRACT

Approaches presented herein enable change detection in a data set underlying a time-dependent visualization by comparing annotation snapshots across time. More specifically, a plurality of annotation snapshots of an annotation generated based on an underlying data set of a time-dependent visualization are obtained at a plurality of points in time. These annotation snapshots are monitored for indicia of a pattern change over time against a predetermined reference point. Whether there has been a pattern change is determined based on the monitoring and, in response to detection of a pattern change, an alert is generated. If there has not been a pattern change, the annotation snapshots are monitored for indicia of an anomaly change over time against the predetermined reference point. Whether there has been an anomaly change is determined based on this monitoring and, in response to detection of an anomaly change, an alert is generated.

### TECHNICAL FIELD

The present invention relates generally to analysis of visualized data and, more specifically, to detecting pattern changes and anomalies in annotations across time-dependent visualizations.

### BACKGROUND

In analytics, a key performance indicator (KPI) is a measurement of an organization's performance in some activity in which the organization is engaged. For example, customer attrition may be a KPI for an insurance company, or employee attrition may be a KPI for a human resources department. Depending on the context of an organization, examples of other KPIs may include measures of quality, profitability, etc. Typically, KPIs are summarized and presented in tables, charts, dashboards, or other succinct visual representation. Human analysts monitor KPIs over time, attempting to detect and understand important changes in data. This monitoring may involve a professional analyst inspecting an entire table, chart, or dashboard, or some subset of elements in a table, chart, or dashboard.

### SUMMARY

Approaches presented herein enable change detection in a data set underlying a time-dependent visualization by comparing annotation snapshots across time. More specifically, a plurality of annotation snapshots of an annotation generated based on an underlying data set of a time-dependent visualization are obtained at a plurality of points in time. These annotation snapshots are monitored for indicia of a pattern change over time against a predetermined reference point. Whether there has been a pattern change is determined based on the monitoring and, in response to detection of a pattern change, an alert is generated. If there has not been a pattern change, the annotation snapshots are monitored for indicia of an anomaly change over time against the predetermined reference point. Whether there has been an anomaly change is determined based on this monitoring and, in response to detection of an anomaly change, an alert is generated.

One aspect of the present invention includes a method for detecting changes in a data set underlying a time-dependent visualization by comparing annotation snapshots across time, the method comprising: obtaining a plurality of annotation snapshots of an annotation generated based on an underlying data set of the time-dependent visualization at a plurality of points in time; monitoring the plurality of annotation snapshots for indicia of a pattern change over time against a predetermined reference point; determining whether there has been a pattern change based on the monitoring; and generating, in response to detecting a pattern change, an alert describing the pattern change.

Another aspect of the present invention includes a computer system for detecting changes in a data set underlying a time-dependent visualization by comparing annotation snapshots across time, the computer system comprising: a memory medium comprising program instructions; a bus coupled to the memory medium; and a processor, for executing the program instructions, coupled to a change detection engine via the bus that when executing the program instructions causes the system to: obtain a plurality of annotation snapshots of an annotation generated based on an underlying data set of the time-dependent visualization at a plurality of points in time; monitor the plurality of annotation snapshots for indicia of a pattern change over time against a predetermined reference point; determining whether there has been a pattern change based on the monitoring; and generate, in response to detecting a pattern change, an alert describing the pattern change.

Yet another aspect of the present invention includes a computer program product for detecting changes in a data set underlying a time-dependent visualization by comparing annotation snapshots across time, the computer program product comprising a computer readable hardware storage device, and program instructions stored on the computer readable hardware storage device, to: obtain a plurality of annotation snapshots of an annotation generated based on an underlying data set of the time-dependent visualization at a plurality of points in time; monitor the plurality of annotation snapshots for indicia of a pattern change over time against a predetermined reference point; determine whether there has been a pattern change based on the monitoring; and generate, in response to detecting a pattern change, an alert describing the pattern change.

Still yet, any of the components of the present invention could be deployed, managed, serviced, etc., by a service provider who offers to implement passive monitoring in a computer system.

Embodiments of the present invention also provide related systems, methods, and/or program products.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments.

FIG. 2 shows a system diagram describing the functionality discussed herein according to illustrative embodiments.

FIGS. 3A-C show an example of detecting changes across a time-dependent data visualization according to illustrative embodiments.

FIGS. 4A-B show another example of detecting changes across a time-dependent data visualization according to illustrative embodiments.

FIG. 5 shows a process flowchart for detecting changes in a data set underlying a time-dependent visualization by comparing annotation snapshots across time according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for change detection in a data set underlying a time-dependent visualization by comparing annotation snapshots across time. More specifically, a plurality of annotation snapshots of an annotation generated based on an underlying data set of a time-dependent visualization are obtained at a plurality of points in time. These annotation snapshots are monitored for indicia of a pattern change over time against a predetermined reference point. Whether there has been a pattern change is determined based on the monitoring and, in response to detection of a pattern change, an alert is generated. If there has not been a pattern change, the annotation snapshots are monitored for indicia of an anomaly change over time against the predetermined reference point. Whether there has been an anomaly change is determined based on this monitoring and, in response to detection of an anomaly change, an alert is generated.

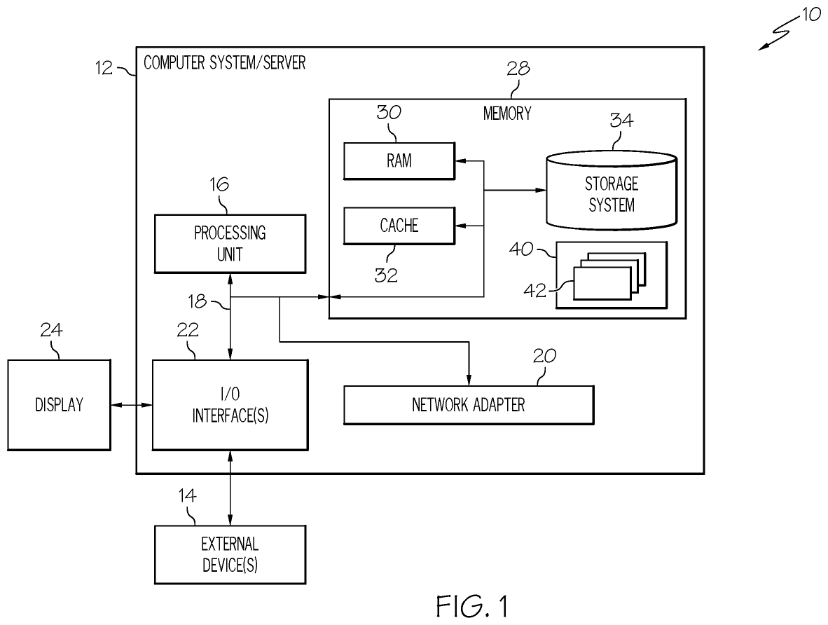

Referring now to FIG. 1, a computerized implementation 10 of an embodiment for detecting changes in a data set underlying a time-dependent visualization by comparing annotation snapshots across time will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein. Computer system/server 12 may be described in the general context of computer system/server executable instructions, such as program modules, being executed by a computer system. Generally, program modules may include routines, programs, objects, components, logic, data structures, and so on, that perform particular tasks or implement particular abstract data types. In this particular example, computer system/server 12 represents an illustrative system for detecting changes in a data set underlying a time-dependent visualization by comparing annotation snapshots across time. It should be understood that any other computers implemented under the present invention may have different components/software, but can perform similar functions.

Computer system/server 12 in computerized implementation 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for detecting changes in a data set underlying a time-dependent visualization by comparing annotation snapshots across time, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The inventors of the present invention have found that the monitoring of KPIs and other business data requires expert-level knowledge of the domain under observation. Specifically, identifying the correct KPIs for an organization, and monitoring them for changes, requires an expert understanding of the organization and its mission. Moreover, such expert-level knowledge is necessary to configure a computer system to continue to monitor for KPIs themselves after the expert analyst has identified them.

Accordingly, the inventors of the present invention have developed a system that automatically monitors changes in enterprise and other organization data without requiring such expertise from a skilled analyst. Embodiments of the present invention use techniques that can automatically summarize and annotate a given visualization (e.g., a table, chart, or dashboard) with visual or text insights based solely on the data underlying the visualization. Embodiments enable automatic monitoring of changes in these annotations across time as the visualization changes over time based solely on the data underlying the visualizations. Furthermore, embodiments enable statistical methods to be applied to solely the data underlying the visualizations in order to verify the change (e.g., as real versus a random fluctuation). Embodiments also offer alerts for detected important changes (e.g., that exceed a threshold). As such, the detection of changes in KPIs can be approximated or accomplished by comparing just an annotation at different times across a time-dependent visualization of the KPIs.

Furthermore, embodiments of the present invention offer several advantages for detecting changes in a data set underlying a time-dependent visualization by comparing annotation snapshots across time. Unlike KPls, the one or more annotations are automatically applied to a visualization, and therefore do not require instructions from an expert analyst for a domain. Nor do annotations or the analysis of the same require access to the underlying record-level data (e.g., raw input data and historical data). Furthermore, embodiments of the present invention can be configured to automatically detect statistical anomalies based on the annotations and can focus on, for example, outliers, trends, and other unusual patterns, in a variety of different types of data visualizations. Other advantages include, for multivariate visualizations, simultaneous monitoring of changes in lower-order sets of fields and determining causes of annotation changes based on changes in the lower-order sets.

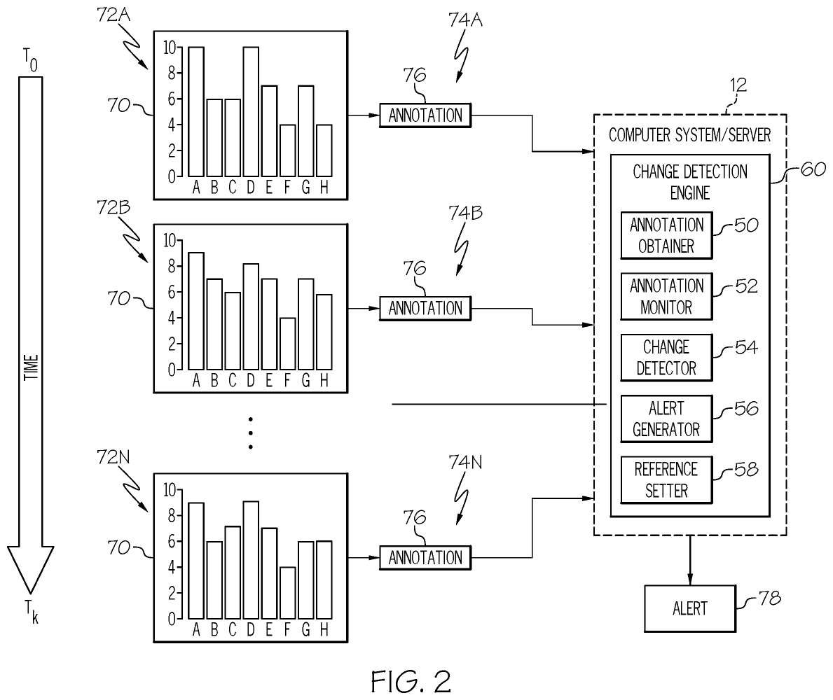

Referring now to FIG. 2, a system diagram describing the functionality discussed herein according to an embodiment of the present invention is shown. It is understood that the teachings recited herein may be practiced within any type of computing environment including, but not limited to, a networked computing environment (e.g., a cloud computing environment). A stand-alone computer system/server 12 is shown in FIG. 2 for illustrative purposes only. In the event the teachings recited herein are practiced in a networked computing environment, each client need not have a change detection engine 60 (hereinafter “system 60”). Rather, all or part of system 60 could be loaded on a server or server-capable device that communicates (e.g., wirelessly) with the clients to provide for detecting changes in a data set underlying a time-dependent visualization by comparing annotation snapshots across time. Regardless, as depicted, system 60 is shown within computer system/server 12. In general, system 60 can be implemented as program/utility 40 on computer system 12 of FIG. 1 and can enable the functions recited herein.

Along these lines, system 60 may perform multiple functions similar to a general-purpose computer. Specifically, among other functions, system 60 can detect changes in a data set underlying a time-dependent visualization by comparing annotation snapshots across time in a networked computing environment. To accomplish this, system 60 can include a set of components (e.g., program modules 42 of FIG. 1) for carrying out embodiments of the present invention. These components can include, but are not limited to, annotation obtainer 50, annotation monitor 52, change detector 54, alert generator 56, and reference setter 58.

Through computer system/server 12, system 60 can obtain a plurality of annotation snapshots 74A-N (denoted as annotation snapshot 74N in the singular) of an annotation 76 generated based on an underlying data set of a time-dependent visualization 70 at a plurality of points in time T₀-Tₖ. (denoted as time Tₖ in the singular), where k>0. According to embodiments of the present invention, annotation snapshots 74A-N of annotation 76 can be pre-generated and attached (e.g., as metadata, as an overlay) to snapshots 72A-N of time-dependent visualization 70. To generate annotation snapshot 74N, system 60, or another computer system, analyzes an underlying data set for visualization snapshot 72N at time Tₖ. According to some embodiments of the present invention, times T₀-Tₖ can be periodic, such that visualization snapshots 72A-N and/or annotation snapshots 74A-N represent the underlying data at even intervals of time.

This underlying data set can include a set of data fields each having a known type of data (e.g., nominal or numeric) and, in some embodiments, may be represented as a table with rows and columns providing the information. The analysis of the underlying data set may include assigning each data field or column utilized in time-dependent data visualization 70 a purpose including: a target (e.g., for a data field or column with values associated with a Y dimension (e.g., of a scatterplot or other chart), counts within a bar chart, etc.); a predictor (e.g., for a data field or column with values associated with an X dimension (e.g., of a scatterplot or other chart), etc.); other (e.g., a data field or column with information used to stack bars by color in a stacked bar chart, etc.); and a label (e.g., a data field or column with one or more values used to label data, show helpful suggestions or other information, etc.). Additionally or alternatively, any suitable purpose or attribute (or indicator of a purpose or attribute) may be assigned to any data field or column of the underlying data set. This assignment may be performed in any suitable manner (e.g., rule-based or cognitive systems, previously assigned, pre-existing data or metadata, field usage in the chart, manual assignment by a user, etc.). In some cases, the underlying data set may include additional fields or columns not utilized in time-dependent data visualization 70.

The analysis of the underlying data set may further include applying a predefined set of detection analytics to values of data points (e.g., target and predictor values) within time-dependent data visualization 70 to identify distinguishing features (e.g., outliers or other points of interest, etc.) and derive one or more corresponding annotations 76. Each of the detection analytics may provide varying parameter values (e.g., degree of abnormality, statistical accuracy, etc.) and add to a set of one or more annotations 76 to time-dependent data visualization 70. The parameter values may vary and correspond to a type of time-dependent data visualization 70 (e.g., scatterplot, bar chart, geographical map, etc.). In one example, the performed detection analytics may be a regression detection analytic to produce an annotation for a resulting fit line through the data points of time-dependent data visualization 70. This example is not intended to be limiting, and it should be understood that the detection analytic may include any conventional or other techniques (e.g., linear or polynomial regression, frequency table analysis (e.g., chi-squared, ANOVA, etc.), time series analysis, geographic/spatial analysis, etc.).

Annotation 76 can include various information about features of data visualization 70 and, by way of example, may include: parameters (e.g., a map of parameter names to values, etc.); rows (e.g., an array of identifiers that determine which subsets of the data point values or rows of the underlying data set are of interest, etc.); or values (e.g., a set of coordinates in a data or coordinate space of data visualization 70 that represents the features of interest). For example, annotation 76 can include information pertaining to parameters for a goodness of fit, slope, and/or other statistical measures and values or coordinates providing start and end points for the fit line in data visualization 70. In another example, one or more annotations 76 may be produced for rows of the underlying data set that contain data point values that are very different (e.g., outliers) representing distinguishable features relative to the data set, where annotation 76 contains information pertaining to: rows (e.g., including row identifiers) indicating which rows of the underlying data set contain data point values that are unusual; values indicating coordinates of the unusual data points (i.e., in the coordinate space of the data visualization), and parameters indicating the degree of abnormality for the indicated rows. The parameters may vary and can correspond to the detection analytics being employed (e.g., a parameter for a regression detection analytic may provide indications of how well a fit line fits, such as an R-squared value, etc.), where the parameters stored in an annotation are preferably dimensionless. Thus, for example, an R-squared goodness-of-fit statistic may be a suitable analytic, while a statistical mean of Y dimension values may not be appropriate (since this is tied to the dimension of the specific data of the Y dimension). Any numeric or string value for the information may be utilized in annotation 76, but utility may be improved when the parameters have a known domain. These examples are not intended to be limiting and annotation 76 may include any desired information pertaining to time-dependent data visualization 70.

In any case, annotation obtainer 50, as performed by computer system/server 12, can obtain a plurality of annotation snapshots 74A-N of annotation 76 generated based on the underlying data set of time-dependent visualization 70 at a plurality of points in time T₀-Tₖ, respectively. Each annotation snapshot 74N is a snapshot of pre-generated annotation 76 and is associated with a snapshot 72N of time-dependent visualization 70 at time Tₖ. Annotation 76, and its snapshots 74A-N, can contain information on the properties of fields in visualization 70, and its snapshots 72A-N, including measurement levels and field roles, based on automatic detection, available metadata, or any other means presently known or later developed. In general, one or more annotations 76 and their underlying statistical analyses can be categorized as one of three types: (1) a test of whether there is a specific pattern in the underlying data; (2) identification of which pattern (among two or more) is in the data; or (3) detection of anomalies.

In some embodiments, annotation obtainer 50 can periodically obtain visualization snapshots 72A-N (e.g., from a user or other computer system) at times T₀-Tₖ and extract annotation snapshots 74A-N from each visualization snapshot 72A-N. In still other embodiments, annotation obtainer 50 can periodically obtain annotation snapshots 74A-N pre-extracted (e.g., by another computer system) from visualization 70 and/or visualization snapshots 72A-N. It should be understood that annotation obtainer 50 can obtain annotation snapshots 74A-N for times T₀-Tₖ through any means presently known or later developed.

Annotation monitor 52, as performed by computer system/server 12, can monitor a plurality of annotation snapshots 74A-N for indicia of a pattern change (and/or an anomaly change) over time against a predetermined reference point. According to some embodiments of the present invention, annotation monitor 52 monitors annotation 76 for the following types of changes: (1) a pattern change, which can include a change in the statistical pattern over time underlying visualization 70 (e.g., a chi-squared test of proportions, an ANOVA F-test, a skewness test, or a t-test of the last added coefficient in a regression model), and whether such a pattern change, if found, has changed from being significant to not significant, or vice versa; and (2) an anomaly change, which can include any change in the anomalies over time underlying visualization 70 (e.g., influential or unusually high/low groups in a bar chart of counts or values, or outliers in a histogram or regression fit line).

According to some embodiments of the present invention, annotation monitor 52 can compare annotation snapshot 74B of data visualization 72B at time T₁ to a predetermined annotation reference point, such as annotation snapshot 74A of data visualization snapshot 72A at time T₀. This monitoring and comparing can continue at times T₂, T₃, . . . Tₖ, . . . , where k>0. In some embodiments this monitoring can be periodic, such that monitoring times are equidistant from one another, or not. In some cases, regular spacing of monitoring times may be desirable in order to enable time series models to be fitted to change scores to permit easier over time analysis, as will be discussed further below. In various embodiments of the present invention, annotation snapshot 74N at time Tₖ (k>0) can be compared against annotation snapshot 74A at time T₀ (i.e., a predetermined reference point), at time Tₖ₋₁ (i.e., an immediately previous reference point), or at time Tₖ₋₅ (i.e., a floating or seasonal reference point), where s=periodicity or seasonal length (e.g., s=12 for monitoring same months across different years). It should be understood that annotation monitor 52 can set any reference time as required. However, for convenience, hereinafter the reference time will be referred to as T₀, with annotation snapshot 74A being the reference annotation snapshot at reference time T₀.

In some embodiments, annotation monitor 52 can first compare annotation snapshot 74N to reference annotation snapshot 74A to monitor time dependent data visualization 70 for a pattern change in annotation snapshot 74N. Annotation monitor 52 can be configured to generate a pattern change score that indicates a strength of a pattern change between annotation snapshot 74N at time Tₖ and reference annotation snapshot 74A at time T₀. In some embodiments, this pattern change score for annotation snapshot 74N is defined as a value between 0 and 1 signifying the pattern change strength, with 1 indicating a definite pattern change and 0 indicating no pattern change.

Based on this monitoring by annotation monitor 52, change detector 54, as performed by computer system/server 12, can determine whether there has been a pattern change. In some embodiments, this pattern change determination can be based on whether the pattern change for annotation snapshot 74N at time Tₖ when compared to reference annotation snapshot 74A at time T₀ is definite (e.g., a switch from non-significant to significant or vice versa) or a switch to a different type of pattern.

According to some embodiments, annotation monitor 52 can next compare annotation snapshot 74N to reference annotation snapshot 74A to monitor time dependent data visualization 70 for an anomaly change through annotation snapshot 74N. Annotation monitor 52 can be configured to generate an anomaly change score that indicates a strength of an anomaly change between annotation snapshot 74N at time Tₖ and reference annotation snapshot 74A at time T₀. In some embodiments, this anomaly change score for annotation snapshot 74N is defined as a value between 0 and 0.99 signifying the anomaly change strength, with 0.99 indicating a definite anomaly change (so that the change score can be used to distinguish whether a pattern change alert or an anomaly change alert should be issued) and 0 indicating no anomaly change.

Based on this monitoring by annotation monitor 52, change detector 54, as performed by computer system/server 12, can determine whether there has been an anomaly change. In some embodiments, this anomaly change determination can be based on whether the anomaly change score for annotation snapshot 74N at time Tₖ when compared to reference annotation snapshot 74A at time T₀ is greater than a threshold anomaly change value, which herein will be denoted as γ.

Alert generator 56, as performed by computer system/server 12, can generate, in response to detection of a pattern (or anomaly) change by change detector 54, alert 78 describing the pattern (or anomaly) change. Alert 78 can include any communication, including a popup, an email, a SMS message, a notification, or any other human or machine readable message. Alert 78 can be addressed to a user or an automated computer system functioning in place of a user. Alert 78 can contain information about the detected change, including, but not limited to, an identity of the changed visualization, at time of the change (Tₖ), a nature of the change (e.g., pattern or anomaly), and a description of the change (e.g., group A outperformed group B, which performed better last year).

In some embodiments, reference setter 58, as performed by computer system/server 12, can set (e.g., at the time of the pattern change detection; at a time annotation obtainer 50 obtains a next annotation in the case the reference time is a floating reference time, as in the case of an immediately previous or periodical/seasonal reference point, etc.) a new reference point against which to compare future annotation snapshots. In some embodiments, reference setter 58 can flag, mark, or otherwise denote annotation snapshot 74A from time T₀ as a reference annotation snapshot against which to compare at least one subsequent annotation snapshot 74N. In various embodiments, this can occur at time T₀ or at any subsequent time. Reference setter 58 can subsequently replace annotation snapshot 74A from time T₀ with a snapshot of annotation 76 at a different time, to serve as the reference annotation snapshot. For example, once annotation monitor 52 compares annotation snapshot 74B from time T₁ against reference annotation snapshot 74A from time T₀, reference setter 58 can adapt annotation snapshot 74B as the new reference annotation snapshot. In some embodiments, this update can be in response to change detector 54 detecting a pattern or anomaly change at time T₁. In some other embodiments, this update can be used to periodically refresh the reference annotation snapshot, cause annotation snapshots to be compared with a previous periodic annotation snapshot (e.g., fourth quarter in year one to fourth quarter in year two), or fulfill any purpose for updating the reference annotation snapshot.

As such, system 60 can monitor and detect not only changes at each time point, but also changes over time. Therefore, for example, if the monitoring times are regularly spaced, the change scores form a regular time series, permitting the detection of sudden spikes/dips or level shifts at some time points. Furthermore, if such changes are discovered, a user can be alerted to investigate further. Alternatively or additionally, system 60 can incorporate the changes as a new pattern directly into the time series model to better forecast changes in the future.

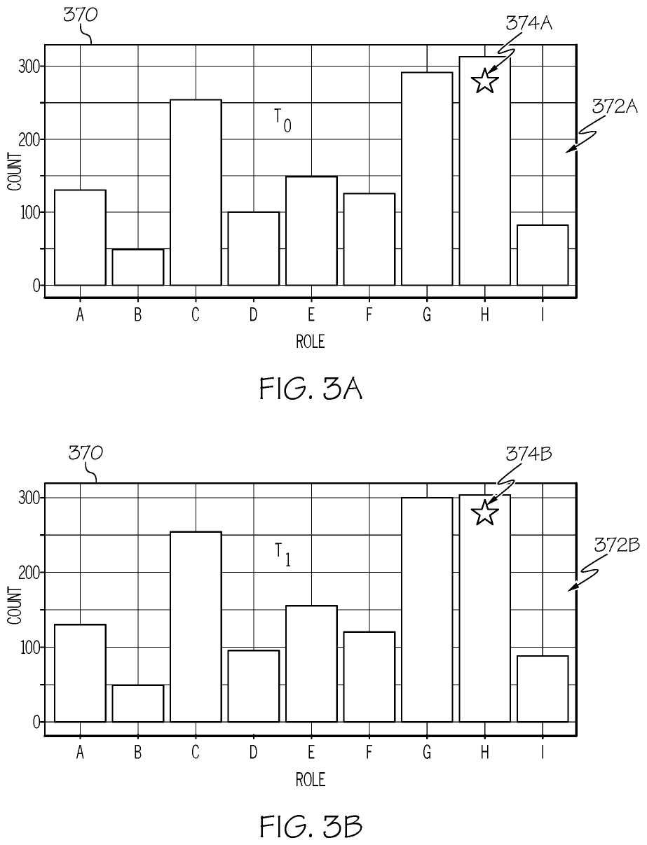

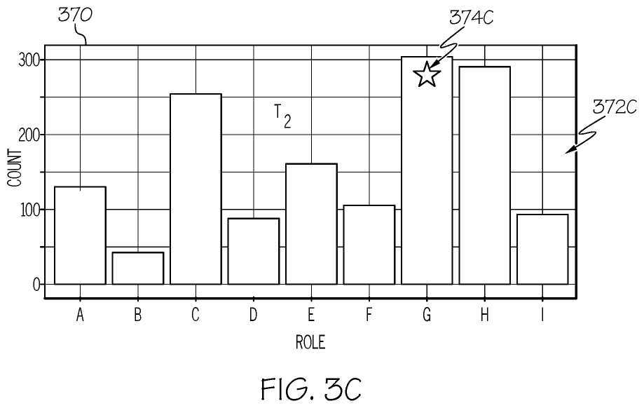

These embodiments will be better understood in view of the illustrative examples shown in FIGS. 3A-3C, in which an example of detecting changes across time-dependent data visualization 370 (herein a bar chart of counts for one categorical field) by comparing annotation snapshots 374A, 374B, and 374C, associated with visualization snapshots 372A, 372B, and 372C at times T₀, T₁, and T₂, respectively, is shown. Specifically referring to FIG. 3A, annotation obtainer 50 can obtain annotation snapshot 374A at time T₀ from visualization snapshot 372A having timestamp T₀. Annotation snapshot 374A can be flagged as a reference annotation by reference setter 58. Accordingly, annotation monitor 52 can perform an initial assessment of annotation snapshot 374A.

Annotation snapshot 374A (and subsequent annotation snapshots 374B and 374C) states whether the counts of the groups in the bar chart are essentially equal (with any differences due to random error) or statistically different. Annotation snapshot 374A may have previously been created via an underlying statistical analysis that used a chi-square test of equal proportions across groups, where the null hypothesis assumed equal proportions, and the alternative hypothesis posited unequal proportions. This underlying statistical analysis would have determined that because the chi-square statistic shows that the proportions are significantly different across categories (e.g., chi-square=441.53, df=8, p-value=2.2e-16) for visualization snapshot 372A of visualization 370 at time T₀, the null hypothesis should be rejected in favor of the alternative hypothesis. As such, annotation snapshot 374A contains the conclusion or end result of this underlying statistical analysis—that the counts of the groups in the bar chart are statistically different—and, in some embodiments, can also include information on the statistical tests used to reach this conclusion.

Furthermore, annotation snapshot 374A (and subsequent annotation snapshots 374B and 374C) can state whether there are any influential groups (i.e., anomalies) with unusually high or low counts. Analysis of the underlying data of visualization 372A at time T₀ may previously have determined that Group H (chi-square=147.41, df=1, adjusted p-value=5.8e-33) is an influential group. As such, annotation snapshot 374A contains the conclusion that Group H has an unusually high count. In some embodiments, this bar of visualization snapshot 372A can be annotated directly with an annotation icon.

Referring now to FIG. 3B, annotation obtainer 50 can obtain annotation snapshot 374B at time T₁ from visualization snapshot 372B having timestamp T₁. As can be seen in FIG. 3B, visualization snapshot 372B shows a state of time-dependent visualization 370 at time T₁ instead of at time T₀. Annotation monitor 52 determines that annotation snapshot 374B indicates that there are slightly different category counts, but that the group proportions are still significantly different. As with annotation snapshot 374A, annotation snapshot 374B may have previously been created via an underlying statistical analysis that used a chi-square test of equal proportions across groups, where the null assumed equal and the alternative posited unequal proportions. This underlying statistical analysis would have determined that because the chi-square statistic shows that the proportions are significantly different across categories (e.g., chi-square=437.69, df=8, p-value=2.2e-16) for visualization 370 at time T₁, the null hypothesis should be rejected in favor of the alternative hypothesis. As such, annotation snapshot 374B indicates that the counts of the groups in the bar chart are statistically different and can include some or all of the statistical tests underlying this conclusion. Analysis of the underlying data of visualization 370 at time T₁ may also have determined that Group H (chi-square=128.29, df=1, p-value=8.7e-29) is an influential group. As such, annotation snapshot 374B indicates that Group H still has the unusually high count and remains an influential group.

Change detector 54 compares annotation snapshot 374B to reference annotation snapshot 374A. Based on these annotations, change detector 54 determines that the pattern test is significant at T₀ and T₁ and that the most influential group is the same at both times. Accordingly, change detector 54 first determines that there is no definite change in pattern, and, because no pattern change has been found, looks for a change in anomalies, but finds that the most influential group is still the same. To make this determination, change detector 54 can compute the anomaly change score as the absolute difference between the effect sizes for the influential group: η=|η_{T}_{₀}−η_{T}_{₁}|=|0.31−0.29|=0.02. (The effect size is used to assess the influence of group count at both times, say η_{T}_{₀} and η_{T}_{ₖ}, and the absolute difference, η=|η_{T}_{₀}−η_{T}_{₁}|, is the change score. If η is greater than threshold γ, then the influential group count has changed substantially.) Assuming the anomaly threshold value γ=0.20, change detector 56 determines that this anomaly change score is not sufficiently large to constitute an anomaly change. It should be understood that, while the initial test for significance assesses whether a change is statistically significant (i.e., real versus due to random fluctuation), effect size measures the magnitude (e.g., strength) of a change. As such, each type of significance test has its own techniques for measuring effect size. In embodiments of the present invention, the calculated effect size is generally not included in an annotation (but may be in some embodiments). Rather, effect size can be used to decide whether an annotation should be shown as well as the annotation contents. In any case, as such, alert generator 58 does not generate alert 78.

Referring now to FIG. 3C, annotation obtainer 50 can obtain annotation snapshot 374C at time T₂ from visualization snapshot 372C having timestamp T₂. Annotation monitor 52 determines that annotation snapshot 374C indicates that there are slightly different category counts, but that the group proportions are still significantly different. Annotation snapshot 374C may have previously been created via an underlying statistical analysis that used a chi-square test of equal proportions across groups, where the null assumed equal and the alternative posited unequal proportions. This underlying statistical analysis would have determined that because the chi-square statistic shows that the proportions are significantly different across categories (e.g., chi-square=445.94, df=8, p-value=2.2e-16) for visualization 370 at time T₂, the null hypothesis should be rejected in favor of the alternative hypothesis. As such, annotation snapshot 374C indicates that the counts of the groups in the bar chart are statistically different and can include some or all of the statistical tests underlying this conclusion. Analysis of the underlying data of visualization 370 at time T₂ would also have determined that Group G (chi-square=134.74, df=1, p-value=3.4e-30) is now an influential group. As such, annotation snapshot 374C indicates that Group G has an unusually high count and is the most influential group.

Change detector 54 compares annotation snapshot 374C to reference annotation snapshot 374A. Based on these annotation snapshots, change detector 54 determines that both the pattern tests are significant at T₀ and T₂, but that the most influential group is different. Accordingly, change detector 54 first determines that there is no definite change in pattern, and, because no pattern change has been found, looks for a change in anomalies, finding the change in most influential group to be an anomaly change. To make this determination, change detector 54 can determine that the most influential group has changed and that in itself is an anomaly change. Therefore, alert generator 58 generates alert 78, informing a user of an anomaly change. Alert generator 58 does not generate an alert for a pattern change.

The decision logic used by system 60 in the example bar chart visualization 370 for generating change scores and determining whether each change score triggers alert 78 is summarized in Table 1 below. At each time Tₖ, an annotation containing computed analytics is compared with an annotation containing computed analytics from T₀. In some embodiments, the test for a pattern change is performed first each time. In these embodiments, the test for anomaly change (e.g., the most influential group) is then performed only if the pattern is significant at T₀ and Tₖ (and therefore there is a pattern against which to check for anomalies). Change scores and alerts for each condition are given in the last two columns. In this example, a change score of 0.99 can be used to indicate an anomaly change as opposed to a pattern change having a change score of 1 to allow alert generator 56 to determine what type of alert to issue.

TABLE 1

| Test against | | Most influential | | | |
|---|---|---|---|---|---|
| hypothesized pattern | | group | | Change | |
| T₀ | Tₖ | T₀ | Tₖ | score | Alert schedule |
| Non- | Significant | | | 1 | Alert for |
| significant | | | | | pattern change |
| Significant | Non- | | | 1 | Alert for |
| | significant | | | | pattern change |
| Significant | Significant | Different | | 0.99 | Alert for |
| | | | | | anomaly change |
| | | Same (compare | | η | Alert for |
| | | the influence | | | anomaly change |
| | | of the group) | | | if η > γ; |
| | | | | | otherwise, no |
| | | | | | alert |
| Non- | Non- | | | 0 | No alert |
| significant | significant | | | | |

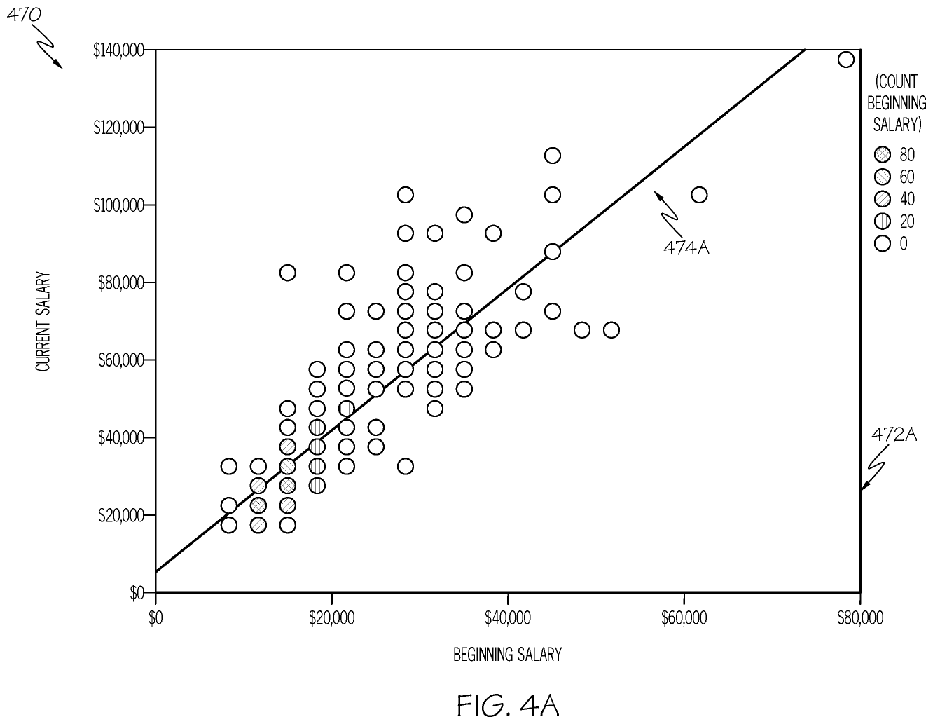

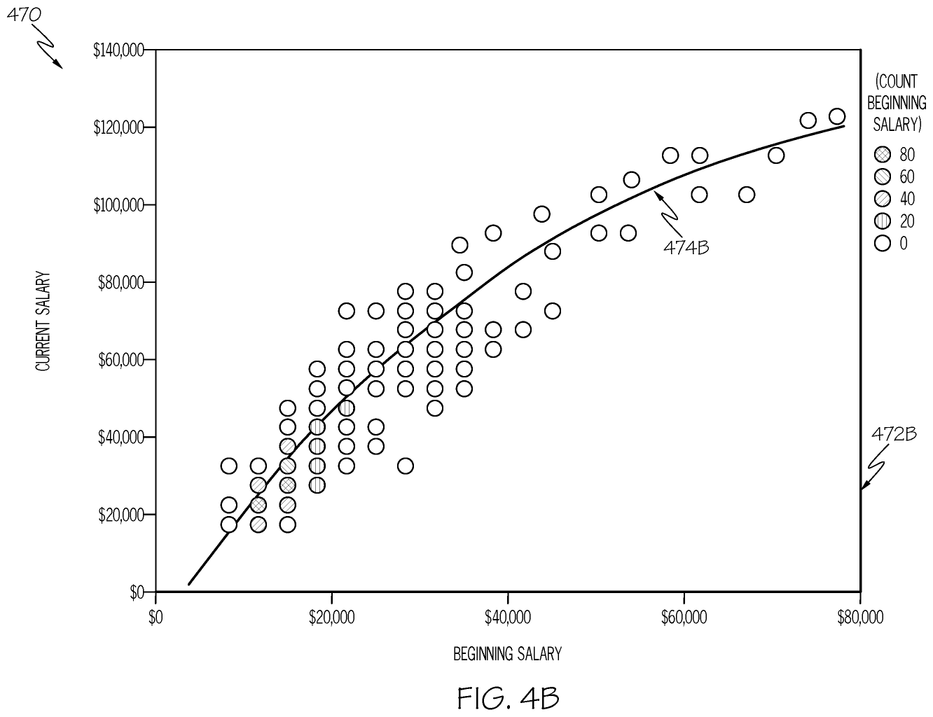

Embodiments will be further better understood in view of the illustrative examples shown in FIGS. 4A and 4B, in which an example of detecting changes across time-dependent data visualization 470 (herein a binned scatterplot for two continuous fields, where the y-axis field is assumed to be the target, and the x-axis field the predictor) by comparing annotation snapshots 474A and 474B from times T₀ and T₁ is shown. Specifically referring to FIG. 4A, annotation obtainer 50 can obtain annotation snapshot 474A at time T₀ from visualization snapshot 472A having timestamp T₀. Annotation snapshot 474A can be flagged as a reference annotation snapshot by reference setter 58. Accordingly, annotation monitor 52 can perform an initial assessment of annotation snapshot 474A.

Annotation snapshot 474A identifies whether a linear or non-linear (polynomial) regression curve/fit line fits the data underlying visualization 470 at time T₀. This identification in annotation snapshot 474A may have previously been generated via an underlying analysis that fits a regression curve/fit line to the data at time T₀. Annotation snapshot 474A can include the linear or non-linear curve (e.g., equation) that fits the data at time T₀. This previous analysis may have also, depending on the fitted curve/fit line, used the residuals (i.e., the differences between observed and fit values) to detect any outliers in the data underlying visualization 470, which can also be identified in annotation snapshot 474A. Based on annotation snapshot 474A, annotation monitor 52 can identify the underlying pattern at time T₀ as a linear model pattern based on the identified regression model. Based on annotation snapshot 474A, annotation monitor 52 can also note that there are no outliers detected at time T₀.

Referring now to FIG. 4B, annotation obtainer 50 can continue to obtain and annotation monitor 52 can continue to monitor annotation snapshots for time-dependent data visualization 470 at various times. In this example, annotation monitor 50 obtains annotation snapshot 474B at time T₁ from visualization snapshot 472B having timestamp T₁. As can be seen in FIG. 4B, visualization snapshot 472B shows a state of time-dependent visualization 470 at time T₁ instead of at time T₀. Annotation monitor 52 determines that annotation snapshot 474B (created via an underlying analysis that fits a regression curve/fit line to the data at time T₁) indicates that the underlying data pattern is best fit by a non-linear (polynomial) curve. Change detector 54 can determine that a change is present between the linear best-fit curve at reference time T₀ and the non-linear/polynomial curve at time T₁. This determination causes alert generator 56 to issue a pattern change alert (i.e., alert 78). As a pattern change has been detected, there is no need to issue an anomaly (e.g., outlier) alert. In some embodiments, in response to the detected pattern change, reference setter 58 can designate time T₁ and its associated annotation snapshot 474B as the new reference time and reference annotation.

The decision logic used by system 60 in the example binned scatterplot visualizations 472A-B for detecting changes and determining whether each change triggers alert 78 is summarized in Table 2 below. At each time Tₖ, an annotation snapshot containing computed analytics is compared with an annotation snapshot containing computed analytics from T₀. In some embodiments, the test for a pattern change is performed first each time. In these embodiments, the test for anomaly change (e.g., whether an outlier exists) is secondly performed only if the pattern is the same at T₀ and Tₖ. In the case that the potential presence of outliers is examined, the strength of the most extreme outlier at both times (i.e., o_{T}_{₀} and o_{T}_{ₖ}) is assessed, where outlier strength values are between 0 and 1 and the absolute difference, o=|o_{T}_{ₒ}−o_{T}_{ₖ}|, is the change score. In this example/table, a change score of 0.99 can be used to indicate an anomaly change as opposed to a pattern change having a change score of 1 to allow alert generator 56 to determine what type of alert to issue. Change scores and alerts for each condition are given in the last two columns.

TABLE 2

| Underlying pattern | | Outlier exists | | Change | |
|---|---|---|---|---|---|
| T₀ | Tₖ | T₀ | Tₖ | score | Alert schedule |
| Different | | | | 1 | Alert for pattern change |
| Same | | False | True | 0.99 | Alert for anomaly change |
| | | True | False | 0.99 | Alert for anomaly change |
| | | True | True | o | Alert for anomaly change if |
| | | | | | o > γ; otherwise, no alert |
| | | False | False | 0 | No alert |

In further embodiments of the present invention, the two-step pattern and then anomaly change detection methods described above can be applied to any number of fields with varying measurement levels and/or field roles. For example, in some embodiments, system 60 can perform monitoring and change detection on annotation snapshots in multivariate and lower-order visualizations simultaneously. In such multivariate visualizations, annotation obtainer 50 can receive annotation snapshots describing the state of lower-order sets of fields at times T₀-Tₖ in a multivariate visualization as it presents at each of these times. Annotation monitor 52 can compare these annotation snapshots at each time Tₖ to effectively monitor the state of each lower-order set of the original visualization. By identifying the lower-order data set or variable responsible for the change, system 60 can explain annotation changes in the original visualization.

For example, when monitoring annotations across time in a scatterplot data visualization that shows a relationship between two continuous fields, annotation obtainer 50 can obtain snapshots of annotations describing each data field individually as histograms of the individual fields across time. Annotation monitor 52 generates a change score for each chart (the scatterplot and two histograms), and then change detector 54 assesses whether changes in the scatterplot are explained by changes in either or both of the histograms and/or individual data fields. When change detector 54 detects a change in one of the lower order sets via a change in the change score, change detector 54 can, in addition to causing alert generator 56 to generate an alert communication, determine which lower order set (i.e., variable) is responsible for the pattern or anomaly change, which alert generator 56 can then include in the alert communication.

As such, by tracking related lower-order visualizations, system 60 not only alerts for changes in a main visualization, but also is enabled to provide an explanation of the changes by referring to other visualizations. For example, when change detector 54 detects that the underlying regression pattern in a scatterplot is changed from a straight line to a parabola, then change detector 54 can isolate this change as being due to, for instance, one field's distribution being changed from symmetric to skewed.

In some embodiments, system 60 can perform monitoring and change detection on annotation snapshots across multiple charts or tables in a dashboard. For example, assume that J annotations are being monitored for a plurality of charts in a dashboard and that snapshots of these J annotations are taken at each of a set of times. At each time of the J annotations, annotation monitor 52 can generate change scores s₁, s₂, . . . , s_{J} for the J annotations. When change detector 54 detects a change in at least one of the annotations, change detector 54 can cause alert generator 56 to generate an alert communication. In some embodiments, this alert can also indicate in which charts of the plurality of charts the changes were detected. Alert generator 56 can follow the following alert schedule based on the findings of change detector 54.

TABLE 3

| Detected Changes | Change score | Alert schedule |
|---|---|---|
| At least one annotation | max(s₁, . . . , s_{J}) = 1 | Alert for pattern change |
| has changed | max(s₁, . . . , s_{J}) > γ | Alert for anomaly change |
| | after removing sⱼ = 1 | |
| All annotations have | min(s₁, . . . , s_{J}) = 1 | Alert for pattern change |
| changed | min(s₁, . . . , s_{J}) > γ | Alert for anomaly change |
| | after removing sⱼ = 1 | |
| Weighted average | if w₁s₁ + . . . + | Alert for some change |
| change score is greater | w_{J} s_{J} > γ, | |
| than a threshold value | | |

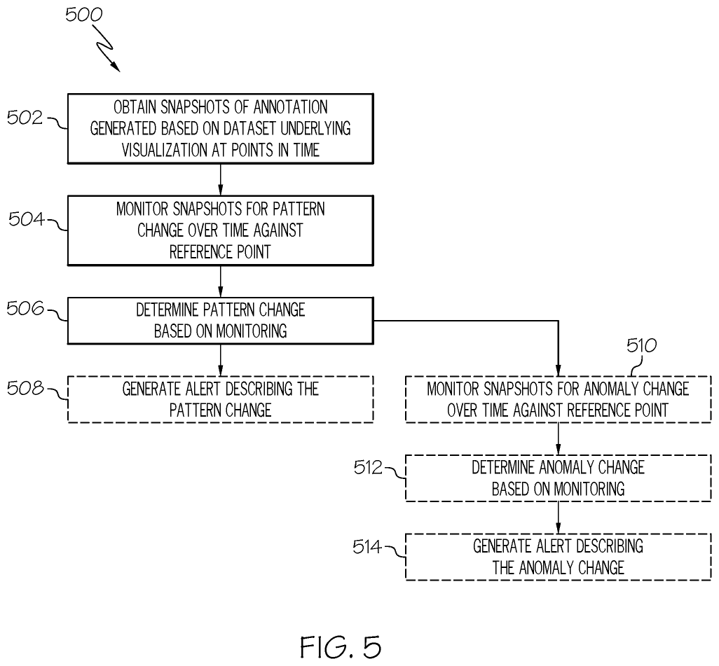

As depicted in FIG. 5, in one embodiment, a system (e.g., computer system/server 12) carries out the methodologies disclosed herein. Shown is a process flowchart 500 for detecting changes in a data set underlying a time-dependent visualization by comparing annotation snapshots across time. At 502, annotation obtainer 50 obtains plurality of annotation snapshots 74A-N of annotation 76 generated based on an underlying data set of time-dependent visualization 70 at a plurality of points in time T₀-Tₖ. At 504, annotation monitor 52 monitors plurality of annotation snapshots 74A-N for indicia of a pattern change over time against a predetermined reference point. At 506, change detector 54 determines whether there has been a pattern change based on the monitoring by annotation monitor 52. At 508, alert generator 56 generates, in response to detection of a pattern change by change detector 54, alert 78 describing the pattern change. At 510, in response to a determination by change detector 54 that there has not been a pattern change, annotation monitor 52 monitors plurality of annotation snapshots 74A-N for indicia of an anomaly change over time against the predetermined reference point. At 512, change detector 54 determines whether there has been an anomaly change based on the monitoring by annotation monitor 52. At 514, alert generator 56 generates, in response to detection of an anomaly change by change detector 54, alert 78 describing the anomaly change.

Process flowchart 500 of FIG. 5 illustrates the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for detecting changes in a data set underlying a time-dependent visualization by comparing annotation snapshots across time. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for detecting changes in a data set underlying a time-dependent visualization by comparing annotation snapshots across time. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches to detect changes in a data set underlying a time-dependent visualization by comparing annotation snapshots across time. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for detecting changes in a data set underlying a time-dependent visualization by comparing annotation snapshots across time, the method comprising:
obtaining a plurality of annotation snapshots of an annotation generated based on an underlying data set of the time-dependent visualization at a plurality of points in time;
monitoring the plurality of annotation snapshots for indicia of a pattern change over time against a predetermined reference point;
determining whether there has been a pattern change based on the monitoring; and
generating, in response to detecting a pattern change, an alert describing the pattern change.

2. The method of claim 1, the method further comprising monitoring, in response to a determination that there has not been a pattern change, the plurality of annotation snapshots for indicia of an anomaly change over time against the predetermined reference point.

3. The method of claim 2, wherein the anomaly change is a change in the anomalies underlying the time-dependent visualization and wherein the pattern change is a change in the statistical pattern underlying the time-dependent visualization.

4. The method of claim 2, the method further comprising:
generating a change score based on the indicia of the pattern change or the indicia of the anomaly change;
determining whether to generate an alert by comparing the change score to a threshold; and
issuing the alert in response to the change score exceeding the threshold.

5. The method of claim 4, the method further comprising setting, at the time of the pattern change or anomaly change determination, a new reference point against which to compare future annotation snapshots.

6. The method of claim 1, wherein each annotation snapshot comprises a feature of the time-dependent visualization at the point in time of the annotation snapshot and wherein the time-dependent visualization comprises a table, chart, or dashboard displaying a summary of the underlying data set.

7. The method of claim 1, wherein the pattern change is a change in a statistical pattern underlying the time-dependent visualization comprising a statistical test changing from significant to not significant or from not significant to significant.

8. The method of claim 7, wherein the statistical test is a test selected from the group consisting of: a chi-squared test, an ANOVA F-test, a skewness test, and a t-test.

9. The method of claim 1, the alert comprising a cause of the pattern change.

10. A computer system for detecting changes in a data set underlying a time-dependent visualization by comparing annotation snapshots across time, the computer system comprising:
a memory medium comprising program instructions;
a bus coupled to the memory medium; and
a processor, for executing the program instructions, coupled to a change detection engine via the bus that when executing the program instructions causes the system to:
obtain a plurality of annotation snapshots of an annotation generated based on an underlying data set of the time-dependent visualization at a plurality of points in time;
monitor the plurality of annotation snapshots for indicia of a pattern change over time against a predetermined reference point;
determine whether there has been a pattern change based on the monitoring; and
generate, in response to detecting a pattern change, an alert describing the pattern change.

11. The computer system of claim 10, the instructions further causing the system to monitor, in response to a determination that there has not been a pattern change, the plurality of annotation snapshots for indicia of an anomaly change over time against the predetermined reference point.

12. The computer system of claim 11, wherein the anomaly change is a change in the anomalies underlying the time-dependent visualization and wherein the pattern change is a change in the statistical pattern underlying the time-dependent visualization comprising a statistical test changing from significant to not significant or from not significant to significant.

13. The computer system of claim 11, the instructions further causing the system to:
generate a change score based on the indicia of the pattern change or the indicia of the anomaly change;
determine whether to generate an alert by comparing the change score to a threshold; and
issue the alert in response to the change score exceeding the threshold.

14. The computer system of claim 13, the instructions further causing the system to set, at the time of the pattern change or anomaly change determination, a new reference point against which to compare future annotation snapshots.

15. The computer system of claim 10, wherein each annotation snapshot comprises a feature of the time-dependent visualization at the point in time of the annotation snapshot and wherein the time-dependent visualization comprises a table, chart, or dashboard displaying a summary of the underlying data set.

16. A computer program product for detecting changes in a data set underlying a time-dependent visualization by comparing annotation snapshots across time, the computer program product comprising a computer readable hardware storage device, and program instructions stored on the computer readable hardware storage device, to:
obtain a plurality of annotation snapshots of an annotation generated based on an underlying data set of the time-dependent visualization at a plurality of points in time;
monitor the plurality of annotation snapshots for indicia of a pattern change over time against a predetermined reference point;
determine whether there has been a pattern change based on the monitoring; and
generate, in response to detecting a pattern change, an alert describing the pattern change.

17. The computer program product of claim 16, the computer readable storage device further comprising instructions to monitor, in response to a determination that there has not been a pattern change, the plurality of annotation snapshots for indicia of an anomaly change over time against the predetermined reference point.

18. The computer program product of claim 17, wherein the anomaly change is a change in the anomalies underlying the time-dependent visualization and wherein the pattern change is a change in the statistical pattern underlying the time-dependent visualization comprising a statistical test changing from significant to not significant or from not significant to significant.

19. The computer program product of claim 17, the computer readable storage device further comprising instructions to:
generate a change score based on the indicia of the pattern change or the indicia of the anomaly change;
determine whether to generate an alert by comparing the change score to a threshold;
issue the alert in response to the change score exceeding the threshold; and
set, at the time of the pattern change or anomaly change determination, a new reference point against which to compare future annotation snapshots.

20. The computer program product of claim 16, wherein each annotation snapshot comprises a feature of the time-dependent visualization at the point in time of the annotation snapshot and wherein the time-dependent visualization comprises a table, chart, or dashboard displaying a summary of the underlying data set.
